(19) United States
(12) Patent Application Publication
(10) Pub. No.: US 2025/0167526 A1
(43) Pub. Date: May 22, 2025

(54) Switchgear

(71) Applicant: ABB Schweiz AG, Baden (CH)

(72) Inventors: Frantisek Koudelka, Menín (CZ); Oliver Baier, Düsseldorf (DE); Lukas Dolezal, Lechovice (CZ); Dalibor Kopp, Brno (CZ); Philipp Masmeier, Bad Nauheim (DE); Ondrej Novak, Velké Pavlovice (CZ); Corrado Rizzi, Fornovo San Giovanni (IT); Pavel Vrbka, Nedvedice (CZ)

(73) Assignee: ABB Schweiz AG, Baden (CH)

(21) Appl. No.: 18/952,339

(22) Filed: Nov. 19, 2024

(30) Foreign Application Priority Data
Nov. 21, 2023 (EP) 23211145.0

(51) Int. Cl. H02B 1/56

(52) U.S. Cl. CPC H02B 1/56

(57) ABSTRACT

A switchgear includes a plurality of circuit breakers; a plurality of first coolers; and at least one first air duct; wherein each circuit breaker of the plurality of circuit breaker has an associated first cooler of the plurality of first coolers thermally connected to it; and wherein the at least one first air duct is configured to direct air from the outside of the switchgear into the plurality of first coolers.

### CROSS-REFERENCE TO RELATED APPLICATIONS

The instant application claims priority to European Patent Application No. 23211145.0, filed Nov. 21, 2023, which is incorporated herein in its entirety by reference.

### FIELD OF THE DISCLOSURE

The present disclosure generally relates to a switchgear, such as for medium voltage applications, and, more particularly, to systems and methods for cooling the switchgear.

### BACKGROUND OF THE INVENTION

Electric switchgears guide electrical currents and therefore generate ohmic losses, resulting in temperature rises. Standards set limits for the permitted temperature rise.

It is very important in medium voltage applications to provide cooling for circuit breakers, where heat is generated via Joule heating due to the passage of electric current.

Heat removal from inner parts of circuit breaker relies on heat conduction to coolers. Coolers can be attached on top, on the arms or other parts of the circuit breaker. Heat from the circuit breaker is conducted to these coolers and the coolers are then cooled by air that is the cooler than the cooler itself.

However, in current designs of the circuit breakers inside switchgears there is not enough space for cold air to flow. This situation is shown in FIG. 1 where areas without colder air flow are shown.

This situation can cause high temperatures inside circuit breaker, which even highly optimized coolers are unable to decrease.

### BRIEF SUMMARY OF THE INVENTION

Therefore, it would be advantageous to have an improved ability to extract thermal energy from switchgear circuit breakers. In a first aspect, there is provided a switchgear, comprising: a plurality of circuit breakers; a plurality of first coolers; and at least one first air duct.

Each circuit breaker of the plurality of circuit breakers has an associated first cooler of the plurality of first coolers thermally connected to it. The at least one first air duct is configured to direct air from the outside of the switchgear into the plurality of first coolers.

Thus, cool air from the outside of the switchgear of the switchgear is forced into a circuit breaker cooler that removes heat from the cooler and thereby increases the efficiency of cooling the circuit breaker.

### BRIEF DESCRIPTION OF THE SEVERAL VIEWS OF THE DRAWING(S)

FIG. 1 shows a schematic representation of the inside of a known switchgear with circuit breakers with coolers, where there are areas without colder air flow.

FIG. 2 shows a schematic representation of an example of a switchgear where air is directed into and out of the coolers of the circuit breakers in accordance with the disclosure.

### DETAILED DESCRIPTION OF THE INVENTION

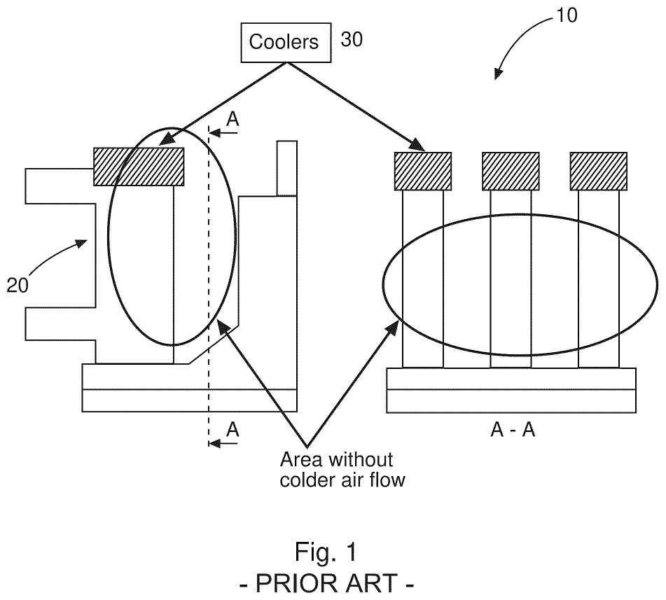

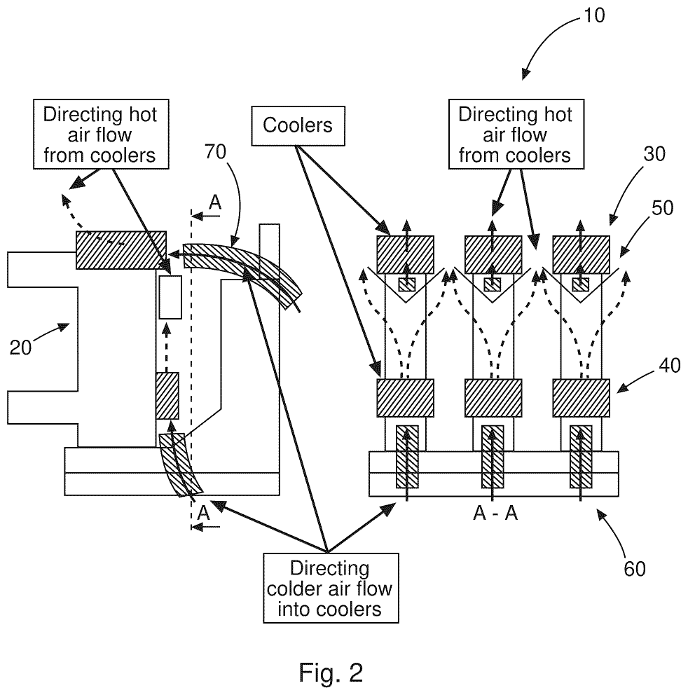

FIG. 1 shows a schematic representation of the inside of a known switchgear with circuit breakers with coolers, where there are areas without colder air flow. FIG. 2 relates to a new switchgear design with improved cooling of circuit breakers.

An exemplar switchgear 10 comprises: a plurality of circuit breakers 20; a plurality of first coolers 30, 40; and at least one first air duct 60, 70. Each circuit breaker of the plurality of circuit breaker has an associated first cooler of the plurality of first coolers thermally connected to it. The at least one first air duct is configured to direct air from the outside of the switchgear into the plurality of first coolers. Thus, cool air from the outside of the switchgear of the switchgear is forced into a circuit breaker cooler that removes heat from the cooler and thereby increases the efficiency of cooling the circuit breaker.

The first cooler can be located anywhere with respect to the circuit breaker: at the top, at the middle, at the bottom, on the side for example. The circuit breakers and associated coolers are inside a compartment of the switchgear. The air ducts lead to holes in the outer walls of the compartment of the switchgear and can have auto closing safety flaps at the compartment wall that close if the pressure in the compartment increases, for example due to a short circuit, thereby providing protection and maintaining hot gases and particulates from being expelled from the compartment.

In an example, the first coolers are heat sinks. In an example, the switchgear comprises at least one second air duct, and the at least one second air duct is configured to direct air exiting the plurality of first coolers to the outside of the switchgear. In this manner, the cool air brought into the switchgear to cool the cooler associated with the circuit breaker, and thus help cool the circuit breaker, is heated due to passage through the cooler and is extracted to the environment outside the switchgear to stop this hot air from heating other components inside the switchgear. Thus, energy is removed from the circuit breaker and from the inside of the switchgear as a whole due to the cool air, brought in from outside the switchgear, being heated in effect by circuit breaker and then this heated air is removed from within the switchgear.

In an example, the air exiting the plurality of first coolers comprises the air from the outside of the switchgear that was directed into the plurality of first coolers by the at least one first air duct.

In an example, the switchgear comprising a plurality of second coolers 30, 40 thermally connected to the plurality of circuit breakers. The switchgear also comprises at least one third air duct 60, 70. Each circuit breaker of the plurality of circuit breaker has an associated second cooler of the plurality of second coolers thermally connected to it. The at least one third air duct is configured to direct air from the outside of the switchgear into the plurality of second coolers.

By having two coolers, that can be located towards ends of the circuit breaker, cooling of the circuit breaker can be improved. The cooling of the circuit breaker is further improved, because the coolers themselves are cooled to extract through directing air from outside the switchgear into the coolers.

In an example, the second coolers are heat sinks.

In an example, the switchgear comprises a plurality of air deflectors 50. The plurality of circuit breakers are orientated vertically, and the plurality of first coolers are located at an upper end of the plurality of circuit breakers, and the plurality of second coolers are located at a lower end of the plurality of circuit breakers. Each circuit breaker of the plurality of circuit breakers has an associated air deflector of the plurality of air deflectors. The air deflector associated with a circuit breaker is configured to deflect air exiting the second cooler associated with the circuit breaker around the first cooler associated with the circuit breaker.

It is to ne noted that an air deflector can itself be an air duct that deflects air by ducting it or be a different kind of air deflector.

In this manner, a cooler at the low end of the circuit breaker is cooled by having air from outside the switchgear forced into and through the cooler and this air is heated and then rises. This heated air is then directed around a cooler for the circuit breaker at the upper end of the circuit breaker to ensure that the upper cooler is not heated by the air that cooled the lower. Thus, the working efficiency of the upper cooler is not compromised. In this way, the overall cooling performance of the circuit breaker is improved.

In an example, the air deflector associated with the circuit breaker is configured to deflect air exiting the second cooler associated with the circuit breaker around either side of the first cooler associated with the circuit breaker. In an example, each air deflector of the plurality of air deflectors comprises a V shape. In an example, each air deflector of the plurality of air deflectors comprises an air duct.

Thus, an air deflector, or guide vane, can be a simple shape like a flat piece of metal bent in the middle to have a V cross section. It is then positioned below the upper cooler with the apex of the triangular cross section guide vane pointing downwards towards the lower cooler. The air that cools the lower cooler that is heated then rises and is diverted in two directions and through appropriate sizing and location of the guide vane, the hot air can be made to bypass the upper cooler and thus not lead to any heating of the upper cooler, which itself is cooled through having cool air from outside the switchgear forced through it.

However, an air deflector can be at least one air duct. Thus, an opening of the air duct can be below the upper cooler and above the lower cooler. The air that cools the lower cooler that is heated then rises and enters the air deflector in the form of an air duct that ducts/deflects the air around the upper cooler and thus not lead to any heating of the upper cooler, which itself is cooled through having cool air from outside the switchgear forced through it.

In an example, the plurality of second coolers are mounted to side surfaces of the plurality of circuit breakers.

In an example, the at least one second air duct is configured to direct air exiting the plurality of second coolers to the outside of the switchgear. This ensures that heated air is fully extracted from the switchgear, providing for improved cooling of the circuit breakers and other components within the switchgear.

In an example, the air exiting the plurality of second coolers comprises the air from the outside of the switchgear that was directed into the plurality of second coolers by the at least one third air duct.

In an example, the plurality of first coolers is mounted to top surfaces of the plurality of circuit breakers.

An exemplary method of cooling a switchgear 10 is now described. The switchgear comprises a plurality of circuit breakers 20, a plurality of first coolers 30, 40, and at least one first air duct 60, 70. Each circuit breaker of the plurality of circuit breaker has an associated first cooler of the plurality of first coolers thermally connected to it. The method comprises: directing, by the at least one first air duct, air from the outside of the switchgear into the plurality of first coolers.

In an example, the switchgear comprises at least one second air duct, and the method comprises: directing, by the at least one second air duct, air exiting the plurality of first coolers to the outside of the switchgear.

In an example, the method comprises: directing, by at least one second air duct, the air exiting the plurality of first coolers that comprises the air from the outside of the switchgear that was directed into the plurality of first coolers by the at least one first air duct.

In an example, the switchgear comprises a plurality of second coolers 30, 40 thermally connected to the plurality of circuit breakers. The switchgear also comprises at least one third air duct 60, 70. Each circuit breaker of the plurality of circuit breaker has an associated second cooler of the plurality of second coolers thermally connected to it. The method comprises: directing, by the at least one third air duct, air from the outside of the switchgear into the plurality of second coolers.

In an example, the switchgear comprises a plurality of air deflectors. The plurality of circuit breakers are orientated vertically. The plurality of first coolers are located at an upper end of the plurality of circuit breakers, and the plurality of second coolers are located at a lower end of the plurality of circuit breakers. Each circuit breaker of the plurality of circuit breakers has an associated air deflector of the plurality of air deflectors. The method comprises: deflecting, by an air deflector associated with a circuit breaker, air exiting the second cooler associated with the circuit breaker around the first cooler associated with the circuit breaker.

It is to ne noted that an air deflector can itself be an air duct that deflects air by ducting it or be a different kind of air deflector.

In an example, the method comprises: deflecting, by the air deflector associated with the circuit breaker, air exiting the second cooler associated with the circuit breaker around either side of the first cooler associated with the circuit breaker.

In an example, each air deflector of the plurality of air deflectors comprises a V shape.

In an example, each air deflector of the plurality of air deflectors comprises an air duct.

In an example, the plurality of second coolers are mounted to side surfaces of the plurality of circuit breakers.

In an example, the method comprises: directing, by the at least one second air duct, air exiting the plurality of second coolers to the outside of the switchgear.

In an example, the method comprises: directing, by the at least one second air duct, the air exiting the plurality of second coolers to the outside of the switchgear and wherein the air exiting the plurality of second coolers comprises the air from the outside of the switchgear that was directed into the plurality of second coolers by the at least one third air duct.

In an example, the plurality of first coolers are mounted to top surfaces of the plurality of circuit breakers.

The new development described above provides a significant improvement in air flow to the coolers of the circuit breaker inside the switchgear and thus improves the removal of heat from the circuit breaker compartment. Thus, in summary the new development relate to improved cooling of circuit breakers inside the medium voltage switchgear applications.

This involves using air ducts to force air into the circuit breaker cooler. This leads to: An increase in the volume of colder air flow through the circuit breaker. This makes it possible to remove higher levels of heat from the circuit breaker. Air ducts provide for a better direction of air flow through the circuit breaker and coolers. Directing the colder air flow into the coolers and hot air flow from the coolers for each cooler separately provides for improved and more effective cooling.

In an example, the first coolers are heat sinks. In an example, the switchgear comprising at least one second air duct, wherein the at least one second air duct is configured to direct air exiting the plurality of first coolers to the outside of the switchgear.

In this manner, the cool air brought into the switchgear to cool the cooler associated with the circuit breaker, and thus help cool the circuit breaker, is heated due to passage through the cooler and is extracted to the environment outside the switchgear to stop this hot air from heating other components inside the switchgear. Thus, energy is removed from the circuit breaker and from the inside of the switchgear as a whole due to the cool air, brought in from outside the switchgear, being heated in effect by circuit breaker and then this heated air is removed from within the switchgear.

In an example, the air exiting the plurality of first coolers comprises the air from the outside of the switchgear that was directed into the plurality of first coolers by the at least one first air duct.

In an example, the switchgear comprising a plurality of second coolers thermally connected to the plurality of circuit breakers. The switchgear also comprises at least one third air duct. Each circuit breaker of the plurality of circuit breaker has an associated second cooler of the plurality of second coolers thermally connected to it. The at least one third air duct is configured to direct air from the outside of the switchgear into the plurality of second coolers.

By having two coolers, that can be located towards ends of the circuit breaker, cooling of the circuit breaker can be improved. The cooling of the circuit breaker is further improved, because the coolers themselves are cooled to extract through directing air from outside the switchgear into the coolers.

In an example, the second coolers are heat sinks. In an example, the switchgear comprises a plurality of air deflectors. The plurality of circuit breakers are orientated vertically, and the plurality of first coolers are located at an upper end of the plurality of circuit breakers, and the plurality of second coolers are located at a lower end of the plurality of circuit breakers. Each circuit breaker of the plurality of circuit breakers has an associated air deflector of the plurality of air deflectors. The air deflector associated with a circuit breaker is configured to deflect air exiting the second cooler associated with the circuit breaker around the first cooler associated with the circuit breaker.

It is to ne noted that an air deflector can itself be an air duct that deflects air by ducting it or be a different kind of air deflector.

In this manner, a cooler at the low end of the circuit breaker is cooled by having air from outside the switchgear forced into and through the cooler and this air is heated and then rises. This heated air is then directed around a cooler for the circuit breaker at the upper end of the circuit breaker to ensure that the upper cooler is not heated by the air that cooled the lower. Thus, the working efficiency of the upper cooler is not compromised. In this way, the overall cooling performance of the circuit breaker is improved.

In an example, the air deflector associated with the circuit breaker is configured to deflect air exiting the second cooler associated with the circuit breaker around either side of the first cooler associated with the circuit breaker.

In an example, each air deflector of the plurality of air deflectors comprises a V shape.

In an example, each air deflector of the plurality of air deflectors comprises an air duct.

Thus, an air deflector, or guide vane, can be a simple shape like a flat piece of metal bent in the middle to have a V cross section. It is then positioned below the upper cooler with the apex of the triangular cross section guide vane pointing downwards towards the lower cooler. The air that cools the lower cooler that is heated then rises and is diverted in two directions and through appropriate sizing and location of the guide vane, the hot air can be made to bypass the upper cooler and thus not lead to any heating of the upper cooler, which itself is cooled through having cool air from outside the switchgear forced through it.

However, an air deflector can be at least one air duct. Thus, an opening of the air duct can be below the upper cooler and above the lower cooler. The air that cools the lower cooler that is heated then rises and enters the air deflector in the form of an air duct that ducts/deflects the air around the upper cooler and thus not lead to any heating of the upper cooler, which itself is cooled through having cool air from outside the switchgear forced through it.

In an example, the plurality of second coolers are mounted to side surfaces of the plurality of circuit breakers.

In an example, the at least one second air duct is configured to direct air exiting the plurality of second coolers to the outside of the switchgear.

This ensures that heated air is fully extracted from the switchgear, providing for improved cooling of the circuit breakers and other components within the switchgear.

In an example, the air exiting the plurality of second coolers comprises the air from the outside of the switchgear that was directed into the plurality of second coolers by the at least one third air duct.

In an example, the plurality of first coolers are mounted to top surfaces of the plurality of circuit breakers.

In a second aspect, there is provided a method of cooling a switchgear. The switchgear comprises a plurality of circuit breakers, a plurality of first coolers, and at least one first air duct. Each circuit breaker of the plurality of circuit breaker has an associated first cooler of the plurality of first coolers thermally connected to it. The method comprises: directing, by the at least one first air duct, air from the outside of the switchgear into the plurality of first coolers.

In an example, the switchgear comprises at least one second air duct, and the method comprises: directing, by the at least one second air duct, air exiting the plurality of first coolers to the outside of the switchgear.

In an example, the method comprises: directing, by at least one second air duct, the air exiting the plurality of first coolers that comprises the air from the outside of the switchgear that was directed into the plurality of first coolers by the at least one first air duct.

In an example, the switchgear comprises a plurality of second coolers thermally connected to the plurality of circuit breakers. The switchgear also comprises and at least one third air duct. Each circuit breaker of the plurality of circuit breaker has an associated second cooler of the plurality of second coolers thermally connected to it. The method comprises: directing, by the at least one third air duct, air from the outside of the switchgear into the plurality of second coolers.

In an example, the switchgear comprises a plurality of air deflectors. The plurality of circuit breakers are orientated vertically. The plurality of first coolers are located at an upper end of the plurality of circuit breakers, and the plurality of second coolers are located at a lower end of the plurality of circuit breakers. Each circuit breaker of the plurality of circuit breakers has an associated air deflector of the plurality of air deflectors. The method comprises: deflecting, by an air deflector associated with a circuit breaker, air exiting the second cooler associated with the circuit breaker around the first cooler associated with the circuit breaker. It is to ne noted that an air deflector can itself be an air duct that deflects air by ducting it or be a different kind of air deflector.

In an example, the method comprises: deflecting, by the air deflector associated with the circuit breaker, air exiting the second cooler associated with the circuit breaker around either side of the first cooler associated with the circuit breaker.

In an example, each air deflector of the plurality of air deflectors comprises a V shape.

In an example, each air deflector of the plurality of air deflectors comprises an air duct.

Thus, an air deflector, or guide vane, can be a simple shape like a flat piece of metal bent in the middle to have a V cross section. It is then positioned below the upper cooler with the apex of the triangular cross section guide vane pointing downwards towards the lower cooler. The air that cools the lower cooler that is heated then rises and is diverted in two directions and through appropriate sizing and location of the guide vane, the hot air can be made to bypass the upper cooler and thus not lead to any heating of the upper cooler, which itself is cooled through having cool air from outside the switchgear forced through it.

However, an air deflector can be at least one air duct. Thus, an opening of the air duct can be below the upper cooler and above the lower cooler. The air that cools the lower cooler that is heated then rises and enters the air deflector in the form of an air duct that ducts/deflects the air around the upper cooler and thus not lead to any heating of the upper cooler, which itself is cooled through having cool air from outside the switchgear forced through it.

In an example, the plurality of second coolers are mounted to side surfaces of the plurality of circuit breakers.

In an example, the method comprises: directing, by the at least one second air duct, air exiting the plurality of second coolers to the outside of the switchgear.

In an example, the method comprises: directing, by the at least one second air duct, the air exiting the plurality of second coolers to the outside of the switchgear and wherein the air exiting the plurality of second coolers comprises the air from the outside of the switchgear that was directed into the plurality of second coolers by the at least one third air duct.

In an example, the plurality of first coolers are mounted to top surfaces of the plurality of circuit breakers.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCE NUMERALS

10 Switchgear
20 Circuit breakers
30 Coolers
40 Coolers
50 Air deflectors/Air ducts
60 Air duct(s)
70 Air duct(s)

What is claimed is:

1. A switchgear, comprising:
a plurality of circuit breakers;
a plurality of first coolers; and
at least one first air duct;
wherein each circuit breaker of the plurality of circuit breaker has an associated first cooler of the plurality of first coolers thermally connected to it; and
wherein the at least one first air duct is configured to direct air from the outside of the switchgear into the plurality of first coolers.

2. The switchgear according to claim 1, further comprising at least one second air duct, wherein the at least one second air duct is configured to direct air exiting the plurality of first coolers to the outside of the switchgear.

3. The switchgear according to claim 2, wherein the air exiting the plurality of first coolers comprises the air from the outside of the switchgear that was directed into the plurality of first coolers by the at least one first air duct.

4. The switchgear according to claim 1, further comprising a plurality of second coolers thermally connected to the plurality of circuit breakers, and at least one third air duct, wherein each circuit breaker of the plurality of circuit breaker has an associated second cooler of the plurality of second coolers thermally connected to it, and wherein the at least one third air duct is configured to direct air from the outside of the switchgear into the plurality of second coolers.

5. The switchgear according to claim 4, the switchgear comprising a plurality of air deflectors, wherein the plurality of circuit breakers are orientated vertically, wherein the plurality of first coolers are located at an upper end of the plurality of circuit breakers, wherein the plurality of second coolers are located at a lower end of the plurality of circuit breakers, wherein each circuit breaker of the plurality of circuit breakers has an associated air deflector of the plurality of air deflectors, and wherein the air deflector associated with a circuit breaker is configured to deflect air exiting the second cooler associated with the circuit breaker around the first cooler associated with the circuit breaker.

6. The switchgear according to claim 5, wherein the air deflector associated with the circuit breaker is configured to deflect air exiting the second cooler associated with the circuit breaker around either side of the first cooler associated with the circuit breaker.

7. The switchgear according to claim 5, wherein each air deflector of the plurality of air deflectors comprises a V shape.

8. The switchgear according to claim 4, wherein the plurality of second coolers are mounted to side surfaces of the plurality of circuit breakers.

9. The switchgear according to claim 4, wherein the at least one second air duct is configured to direct air exiting the plurality of second coolers to the outside of the switchgear.

10. The switchgear according to claim 9, wherein the air exiting the plurality of second coolers comprises the air from the outside of the switchgear that was directed into the plurality of second coolers by the at least one third air duct.

11. The switchgear according to claim 1, wherein the plurality of first coolers are mounted to top surfaces of the plurality of circuit breakers.

12. A method of cooling a switchgear, comprising:
providing a plurality of circuit breakers;
providing a plurality of first coolers and at least one first air duct, wherein each circuit breaker of the plurality of circuit breaker has an associated first cooler of the plurality of first coolers thermally connected to it;
directing, by the at least one first air duct, air from the outside of the switchgear into the plurality of first coolers.

13. The method according to claim 12, further comprising:
providing a plurality of second coolers thermally connected to the plurality of circuit breakers and at least one third air duct, wherein each circuit breaker of the plurality of circuit breaker has an associated second cooler of the plurality of second coolers thermally connected to it; and
directing, by the at least one third air duct, air from the outside of the switchgear into the plurality of second coolers.

14. The method according to claim 13, further comprising:
providing a plurality of air deflectors, wherein the plurality of circuit breakers are orientated vertically, wherein the plurality of first coolers are located at an upper end of the plurality of circuit breakers, wherein the plurality of second coolers are located at a lower end of the plurality of circuit breakers, wherein each circuit breaker of the plurality of circuit breakers has an associated air deflector of the plurality of air deflectors; and
deflecting, by an air deflector associated with a circuit breaker, air exiting the second cooler associated with the circuit breaker around the first cooler associated with the circuit breaker.

15. The method according to claim 14, further comprising deflecting, by the air deflector associated with the circuit breaker, air exiting the second cooler associated with the circuit breaker around either side of the first cooler associated with the circuit breaker.
